(19) United States
(12) Patent Application Publication
(10) Pub. No.: US 2004/0224688 A1
(43) Pub. Date: Nov. 11, 2004

(54) Method of setting up connections in a mobile radio system

(75) Inventor: Patrick Fischer, Bourg La Reine (FR)

Correspondence Address: SUGHRUE MION, PLLC, Suite 800, 2100 Pennsylvania Avenue, N.W., Washington, DC, 20037-3213, US

(73) Assignee: EVOLIUM S.A.S.

(21) Appl. No.: 10/839,173

(22) Filed: May 6, 2004

(30) Foreign Application Priority Data
May 7, 2003 (FR) 03 05 602

(51) Int. Cl. H04Q 7/20

(52) U.S. Cl. 455/435.1; 455/422.1

(57) ABSTRACT

A method of establishing a connection between a mobile terminal and a network in a mobile radio system, for a mobile terminal having a radio control connection established with the radio access network of said system, the method comprising the mobile terminal sending the radio access network at least one establishment cause item of information indicating a connection establishment cause and/or a call establishment cause in the case of a connection establishment cause corresponding to establishing a call.

The present invention relates generally to mobile radio systems.

Mobile radio systems are generally covered by standards, and the corresponding standards published by the corresponding standardization organizations may be consulted for a complete description of these systems.

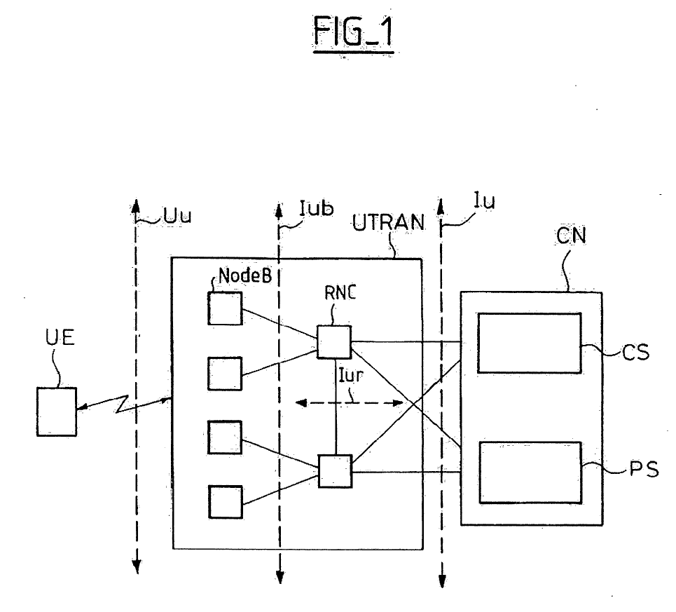

FIG. 1 outlines the general architecture of a mobile radio system, such as a Universal Mobile Telecommunication System (UMTS) type system in particular. The system comprises a mobile radio network communicating with mobile terminals, also known as user equipments (UE), and with external networks (not specifically shown).

The mobile radio network comprises:

a UMTS terrestrial radio access network (UTRAN), and

a core network (CN).

Third generation systems, in particular systems of the Universal Mobile Telecommunication System (UMTS) type, use a wideband-code division multiple access (W-CDMA) radio access technology. The UTRAN comprises base stations known as Nodes B and base station controllers known as radio network controllers (RNC). The UTRAN communicates with the mobile terminals UE via a radio interface Uu and with the core network CN via an interface Iu. Within the UTRAN, the Node B base stations communicate with the base station controllers RNC via an interface Iub, and there may also be an interface Iur between RNCs.

Third generation systems, in particular systems of the UMTS type, use different core network technologies: a circuit-switched (CS) technology corresponding to a CS domain and a packet-switched (PS) technology corresponding to a PS domain.

Third generation systems, in particular systems of the UMTS type, must generally be able to support traffic with very different quality of service (QoS) requirements. To guarantee quality of service at different levels of this kind of system, a QoS architecture has been defined with different support services (such as, in particular: radio access bearer (RAB) services between the CN and the UE, radio bearer (RB) services between the RNC and the UE, etc.) and different QoS attributes (such as, in particular: traffic class, maximum bit rate, guaranteed binary bit rate, transfer delay, etc.). There are four traffic classes: conversational applications, streaming applications, interactive applications, and background applications.

As a general rule, these systems may transmit different types of data, namely data corresponding to user data or traffic and data corresponding to control data or signaling necessary for the system itself to operate. Different protocols have been defined for exchanging data between different elements of these systems, including, for the exchange of signaling in particular:

the Radio Access Network Application Part (RANAP) protocol as defined in Technical Specification 3GPP TS 25.413, for exchange of signaling between the CN and the RNC,

the Radio Network Subsystem Application Part (RNSAP) protocol as defined in Technical Specification 3GPP TS 25.423, for exchange of signaling between RNCs interconnected via an Iur interface,

the Node B Application Part (NBAP) protocol as defined in Technical Specification 3GPP TS 25.433, for exchange of signaling between the RNC and the Node B base stations, and

the Radio Resource Control (RRC) protocol as defined in Technical Specification 3GPP TS 25.331, for exchange of signaling between the RNC and the UE.

Different types of channels have been defined for exchanging data between the UE and the UTRAN, corresponding to different protocol layers, namely logical channels, transport channels, and physical channels. Common channels (which are shared between a plurality of users) are also distinguished from dedicated channels (which are reserved to one user). In particular, dedicated channels may be assigned to send priority data (in particular traffic having the highest quality of service constraints) and common channels may be assigned to send lower priority data (in particular traffic having lower quality of service constraints). For example, in the case of transport channels, dedicated channels (DCH) are distinguished from common channels, including in particular paging channels (PCH), forward access channels (FACH), common packet channels (CPCH), and downlink shared channels (DSCH).

The RNC handles radio resource management functions (including call admission control, power control, handover control, etc.), in particular with the aim of guaranteeing the quality of service for RB services in conjunction with efficient utilization of the available radio resources. For optimized radio resource management, the RNC also handles certain mobility management functions. Thus mobility management algorithms have been defined at the UTRAN level, based on a system of RRC states and transitions between those states.

Two UE modes can therefore be distinguished:

an idle mode in which there is no connection between the UE and the UTRAN, and the UTRAN has no information on the location of the UE, and

a connected mode in which there is a connection between the UE and the UTRAN, and the UTRAN has information on the location of the UE.

Different states are distinguished within the connected mode:

a Cell_DCH state in which dedicated resources are assigned to the UE and the location of the terminal is known to the UTRAN at the active set cell or cells level, thanks to handover mechanisms,

a Cell_FACH state in which common resources are assigned to the UE and the location of the terminal is known at the cell level, thanks to an RRC Cell Update procedure,

a Cell_PCH state in which the UE can be contacted only by means of a paging procedure and the location of the terminal is known at the cell level thanks to the RRC Cell Update procedure, and

a URA_PCH state in which the UE can be contacted only by means of a paging procedure and the location of the terminal is known at the set of cells or UTRAN registration area (URA) level, thanks to an RRC URA Update procedure.

Examples of transitions between states include:

a UE changes from the idle mode to the Cell_FACH or Cell_DCH state on call establishment,

once the UE is in the Cell_FACH or Cell_DCH state, it can change to the Cell_PCH or URA_PCH state if there is temporarily no data to be sent,

once the UE is in the Cell_PCH or URA_PCH state, it may change to the Cell_FACH state if there is again data to be sent, or to execute a cell or URA update procedure, if necessary, after which the UE may retain to the Cell_PCH or URA_PCH state, and

a UE may also change from the Cell_FACH state to the Cell_DCH state.

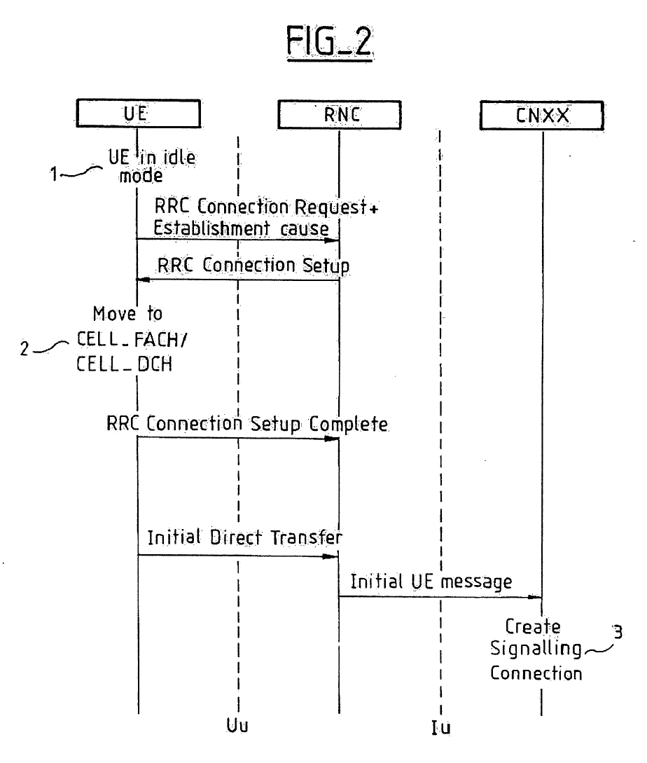

Certain exchanges of signaling used to establish a call in a system of the above kind are described next with reference to FIGS. 2, 3 and 4. The same reference symbols are used for elements common to more than one figure.

FIG. 2 relates to a UE that is initially in the idle mode, as shown at 1. In this case, establishing a connection starts with establishing a radio control connection (RRC connection) between the UE and the UTRAN.

Accordingly, when the UE wishes to establish a connection, using the RRC protocol, it sends the RNC an RRC connection request message, as defined in Technical Specification 3GPP TS 25.331. That message includes establishment cause information (RRC Connection Request+Establishment Cause). The establishment cause information includes, in particular:

whether the connection is required to send user traffic, and if so:

whether the terminal is the origin of the call, i.e. if it is a mobile originating or mobile terminating call,

the required class of traffic, namely one of the following traffic classes: conversational, streaming, interactive or background,

whether the connection is for an emergency call,

whether the request is a call re-establishment request,

whether the connection is required for sending signaling, and if so whether the signaling is priority or non-priority signaling.

On the basis of information contained in the RRC connection request message, and in particular on the basis of the establishment cause indicated therein, the RNC may then allocate radio resources to the UE (or Signaling Radio Bearer (SRB)) for the RRC connection.

The RNC then sends the UE an RRC Connection Setup message indicating the resources assigned for the RRC connection. Reception of this message by the UE then commands a change of the UE to the Cell_FACH or Cell_DCH state, as depicted at 2. The UE then sends the RNC an RRC Connection Setup Complete message, which terminates the RRC connection establishment procedure.

Establishing the connection continues with establishing a signaling connection between the UE and the CN, the signaling exchanged by means of this connection corresponding to signaling exchanged in accordance with a higher level (Non-Access Stratum (NAS)) level protocol. Using the resources assigned to it for the RRC connection, the UE sends the RNC an RRC Initial Direct Transfer message containing information addressed to the CN. The RNC forwards this information to the appropriate CN domain CN XX (i.e. CN CS or CN PS) in a UE Initial Message sent in accordance with the RANAP protocol.

A signaling connection between the UE and the CN is finally created, as depicted at 3. Establishing the connection may then continue in accordance with mechanisms specific to the NAS protocol.

A connection may equally be established when the UE is in the connected mode, rather than the idle mode. This corresponds, in particular, to a multicall situation, for example the situation of a UE wishing to initiate a circuit-switched call (connection with the CN CS domain) when it is engaged in a packet-switched session (connection with the CN PS domain).

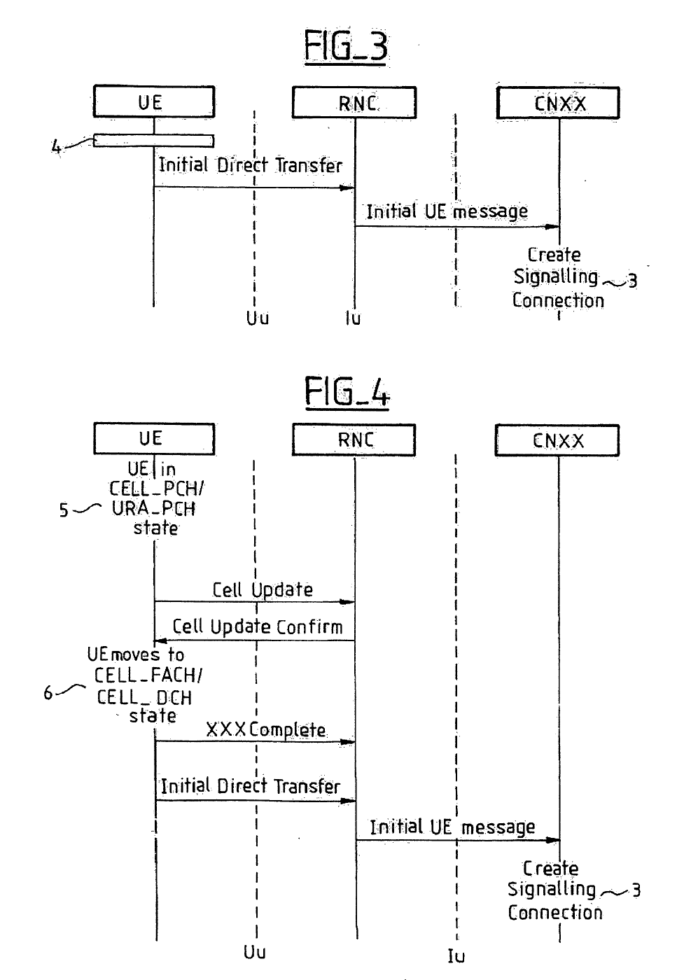

FIGS. 3 and 4 depict connection establishment for a UE that is not initially in the idle mode.

In FIG. 3, the UE is initially in the Cell_FACH or Cell_DCH state, as depicted at 4. In this case, the UE sends the Initial Direct Transfer message directly to the RNC and the subsequent steps include, as in FIG. 2, the RNC sending the CN the Initial UE Message, and then the creation of a signaling connection between the UE and the CN, as depicted at 3.

In FIG. 4, the UE is initially in the Cell_PCH or URA_PCH, as depicted at 5. In this case, a cell update RRC procedure is needed first, that procedure including the UE sending the RNC an RRC Cell Update message and the RNC then sending the UE a Cell Update Confirm message. The UE then changes to the Cell_FACH or Cell_DCH state, as depicted at 6. The UE then sends the Initial Direct Transfer message to the RNC and the subsequent steps comprise, as in FIGS. 2 and 3, the RNC sending the CN the Initial UE Message followed by the creation of a signaling connection between the UE and the CN, as depicted at 3.

As explained next, the Applicant has found that problems arise in the situations depicted in FIGS. 3 and 4 of setting up connections from the connected mode, especially in the case of emergency calls. An emergency call is not usually processed like a normal call: in particular, if the RNC knows that it is an emergency call, it may decide to release another call of lower priority, for example, or other actions may be envisaged with a view to freeing up resources for the emergency call, such as reconfiguring other calls, etc.

In the situation depicted in FIG. 3, and under the current version of the standard, when it receives the Initial Direct Transfer message, the RNC does not know the connection establishment cause, and in particular does not know if it is a matter of establishing a connection for establishing an emergency call. Under these conditions, the RNC treats the connection as a normal connection, and thus the connection may not be accepted by the RNC or may be accepted with a delay, which can have serious consequences, in particular for an emergency call. More generally, the RNC knows only that a connection must be established, but does not know the establishment cause for the connection, and in this case the RNC does not process establishing the connection in a manner appropriate to that cause.

In the situation depicted in FIG. 4, and under the current version of the standard, on receiving the Cell Update message, the RNC does not know the connection establishment cause, and in particular does not know if it is a matter of establishing a connection for establishing an emergency call. Under the current version of the standard, the possible cell update causes that may be indicated in the cell update message (such as, in particular, cell reselection, periodical cell update, uplink data transmission, paging response) do not include a connection establishment cause. The RNC may then not process this cell update request appropriately, especially if the object is to send an Initial Direct Transfer message, in particular to establish an emergency call. Besides, as indicated above in relation to FIG. 3, under the current version of the standard, on receiving the Initial Direct Transfer message, the RNC does not know the connection establishment cause, and in particular does not know if it is a matter of establishing a connection for establishing an emergency call, and the RNC may not process the establishment of this connection in a manner appropriate to that cause.

A particular object of the present invention is to solve some or all of the above problems. A more general object of the present invention is to improve the quality of service in such systems.

In one aspect the present invention consists in a method of establishing a connection between a mobile terminal and a network in a mobile radio system, for a mobile terminal having a radio control connection established with the radio access network of said system, the method comprising the mobile terminal sending the radio access network at least one establishment cause item of information indicating a connection establishment cause and/or a call establishment cause in the case of a connection establishment cause corresponding to establishing a call.

According to another feature of the invention, said establishment cause information is contained in a message sent by the mobile terminal to initiate a cell update procedure.

According to another feature of the invention, in a UMTS type system, said message corresponds to the Cell Update message.

According to another feature of the invention, said establishment cause information is contained in a message sent by the mobile terminal to establish a signaling connection between the mobile terminal and the core network.

According to another feature of the invention, said message corresponds to the Initial Direct Transfer message.

According to another feature of the invention, where applicable, said establishment cause item of information indicates an emergency call.

Another aspect of the invention provides a mobile terminal comprising means for implementing the above method.

Another aspect of the invention provides a radio network equipment, in particular a radio network controller, comprising means for implementing the above method.

Another aspect of the invention provides a mobile radio system comprising means for implementing the above method.

Other objects and features of the present invention will emerge on reading the following description of one embodiment of the invention, which is given with reference to the appended drawings, in which:

FIG. 1 outlines the general architecture of a mobile radio system,

FIGS. 2, 3 and 4 outline certain exchanges of signaling necessary for establishing a connection in this kind of system, starting from different RRC states of a mobile terminal, and

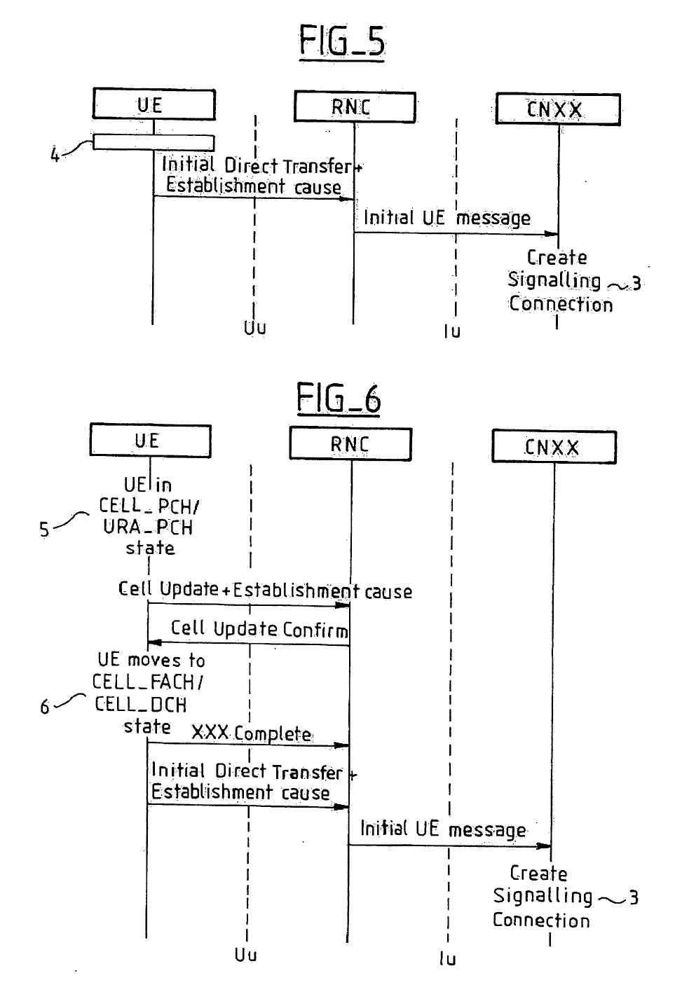

FIGS. 5 and 6 depict examples of connection establishment methods of the invention, starting from different RRC states of a mobile terminal, in this instance respectively corresponding to the RRC states considered in FIGS. 3 and 4.

The present invention suggests, in particular, for a mobile terminal having a radio control connection (RRC connection) established with the radio access network, that the mobile terminal send the radio access network at least one item of information referred to herein as an establishment cause indicating a connection establishment cause and/or a call establishment cause in the case of a connection establishment cause corresponding to establishing a call.

In particular, said establishment cause information may be contained in a message sent by the mobile terminal to establish a signaling connection between the mobile terminal and the core network. In particular, in a UMTS type system, said message may be an Initial Direct Transfer message.

Said establishment cause information may also be contained in a message sent by the mobile terminal to initiate a cell update procedure. In particular, in a UMTS type system, said message may be an RRC Cell Update message.

FIGS. 5 and 6 depict examples of connection establishment methods of the invention, starting from RRC states corresponding to the situations depicted in FIGS. 3 and 4, respectively.

Thus FIG. 5 depicts the situation of establishing a connection from the Cell_FACH or Cell_DCH state, as depicted at 4. The UE then sends the RRC Initial Direct Transfer message directly, as depicted in FIG. 5. As also depicted in FIG. 5, the RRC Initial Direct Transfer message includes an establishment cause (RRC Initial Direct Transfer+Establishment Cause). The RNC may then process the establishment of this connection in a manner appropriate to its establishment cause; in particular, for an emergency call, the RNC may decide, for example, to release another call of lower priority in order to free up resources for the emergency call. For example, the establishment cause may correspond to the establishment cause as defined in the current version of the standard for transmission in the RRC Connection Request message, as mentioned above. In this example, this establishment cause then indicates a connection establishment cause and a call establishment cause in the case of a connection establishment cause corresponding to establishing a call. In a different example, the establishment cause could indicate a connection establishment cause or a call establishment cause in the case of a connection establishment cause corresponding to establishing a call.

FIG. 6 depicts establishing a connection starting from the Cell_PCH or URA_PCH state, as depicted at 5. The UE then starts by sending an RRC Cell Update message, as depicted in FIG. 6. As also depicted in FIG. 6, the RRC Cell Update message includes an establishment cause (Cell Update+Establishment Cause). The RNC may then process the establishment of this connection in a manner appropriate to its establishment cause; in particular, for an emergency call, the RNC may decide, for example, to release another call of lower priority in order to free up resources for the emergency call. For example, the establishment cause may correspond to the establishment cause as defined in the current version of the standard for transmission in the RRC Connection Request message, as mentioned above. In this example, this establishment cause then indicates a connection establishment cause and a call establishment cause in the case of a connection establishment cause corresponding to establishing a call. In a different example, the establishment cause could indicate a connection establishment cause or a call establishment cause in the case of a connection establishment cause corresponding to establishing a call.

Furthermore, in the example depicted in FIG. 6, the RRC Initial Direct Transfer message includes, as in the example depicted in FIG. 5, an establishment cause (RRS Initial Direct Transfer+Establishment Cause).

The present invention also provides a mobile terminal, a radio access network equipment (in particular a radio access network controller), and a mobile radio system all comprising means for implementing a method of the above kind.

The particular implementation of such means representing no particular difficulty for the person skilled in the art, such means need not be described here in more detail than by stating their function, as above.

Thus the invention also provides a mobile terminal comprising means for sending to the radio access network of a mobile radio system, to establish a connection between the mobile terminal and the network in the situation where said mobile has a radio control connection established with said radio access network, at least one establishment cause item of information indicating a connection establishment cause and/or a call establishment cause in the case of a connection establishment cause corresponding to establishing a call.

In particular, said terminal comprises means for sending said establishment cause information in a message sent by the mobile terminal to initiate a cell update procedure.

In particular, in a UMTS type system, said message corresponds to the Cell Update message.

In particular, said terminal comprises means for sending said establishment cause information in a message sent by the mobile terminal to establish a signal connection between the mobile terminal and the core network.

In particular, in a UMTS type system, said message corresponds to the Initial Direct Transfer message.

In particular, said establishment cause information indicates if a call is an emergency call.

Thus the present invention also provides a mobile radio network equipment, in particular a radio network controller, comprising means for receiving from a mobile terminal, to establish a connection between the mobile terminal and the network in the situation in which said terminal has a radio control connection established with said radio access network, at least one establishment cause item of information indicating a connection establishment cause and/or a call establishment cause in the case of a connection establishment cause corresponding to establishing a call.

In particular, said network equipment comprises means for receiving said establishment cause information in a message sent by the mobile terminal to initiate a cell update procedure.

In particular, in a UMTS type system, said message corresponds to the Cell Update message.

In particular, said network equipment comprises means for receiving said establishment cause information in a message sent by the mobile terminal to establish a signal connection between the mobile terminal and the core network.

In particular, in a UMTS type system, said message corresponds to the Initial Direct Transfer message.

In particular, said establishment cause information indicates if a call is an emergency call.

Thus the present invention also provides a mobile radio system comprising at least one such mobile terminal and/or at least one such network equipment.

1. A method of establishing a connection between a mobile terminal and a network in a mobile radio system, for a mobile terminal having a radio control connection established with the radio access network of said system, the method comprising the mobile terminal sending the radio access network at least one establishment cause item of information indicating a connection establishment cause and/or a call establishment cause in the case of a connection establishment cause corresponding to establishing a call.

2. A method according to claim 1, wherein said establishment cause information is contained in a message sent by the mobile terminal to initiate a cell update procedure.

3. A method according to claim 2, wherein, in a UMTS type system, said message corresponds to the Cell Update message.

4. A method according to claim 1, wherein said establishment cause information is contained in a message sent by the mobile terminal to establish a signaling connection between the mobile terminal and the core network.

5. A method according to claim 4, wherein, in a UMTS type system, said message corresponds to the Initial Direct Transfer message.

6. A method according claim 1, wherein, where applicable, said establishment cause item of information indicates an emergency call.

7. A mobile terminal comprising means for sending to the radio access network of a mobile radio system, to establish a connection between the mobile terminal and the network in the situation where said terminal has a radio control connection established with said radio access network, at least one establishment cause item of information indicating a connection establishment cause and/or a call establishment cause in the case of a connection establishment cause corresponding to establishing a call.

8. A terminal according to claim 7, comprising means for sending said establishment cause item of information in a message sent by the mobile terminal to initiate a cell update procedure.

9. A terminal according to claim 8, wherein, in a UMTS type system, said message corresponds to the Cell Update message.

10. A terminal according to claim 7, comprising means for sending said establishment cause item of information in a message sent by the mobile terminal to establish a signaling connection between the mobile terminal and the core network.

11. A terminal according to claim 10, wherein, in a UMTS type system, said message corresponds to the Initial Direct Transfer message.

12. A terminal according to claim 7, wherein, where applicable, said establishment cause item of information indicates an emergency call.

13. Mobile radio network equipment, in particular a radio network controller, comprising means for receiving from a mobile terminal, to establish a connection between the mobile terminal and the network in the instance where said terminal has a radio control connection established with said radio access network, at least one establishment cause item of information indicating a connection establishment cause and/or a call establishment cause in the case of a connection establishment cause corresponding to establishing a call.

14. Network equipment according to claim 13, comprising means for receiving said establishment cause item of information in a message sent by the mobile terminal to initiate a cell update procedure.

15. Network equipment according to claim 14, wherein, in a UMTS type system, said message corresponds to the Cell Update message.

16. Network equipment according to claim 13, comprising means for receiving said establishment cause information in a message sent by the mobile terminal to establish a signaling connection between the mobile terminal and the core network.

17. Network equipment according to claim 16, wherein, in a UMTS type system, said message corresponds to the Initial Direct Transfer message.

18. Network equipment according to wherein, where applicable, the establishment cause item of information indicates an emergency call.

19. A mobile radio system comprising at least one mobile terminal according to claim 7.

20. A mobile radio system comprising at least one network equipment according to claim 13.
